(19) United States
(12) Patent Application Publication
(10) Pub. No.: US 2008/0100435 A1
(43) Pub. Date: May 1, 2008

(54) Remote sensor with multiple sensing and communication modes

(76) Inventors: Joel Jorgenson, Fargo, ND (US); Michael Schmitz, Fargo, ND (US); Bradley Thurow, Fargo, ND (US)

Correspondence Address: MARSH, FISCHMANN & BREYFOGLE LLP, 3151 SOUTH VAUGHN WAY, SUITE 411, AURORA, CO, 80014, US

(21) Appl. No.: 11/281,239

(22) Filed: Nov. 17, 2005

Related U.S. Application Data
(63) Continuation of application No. 11/086,780, filed on Mar. 22, 2005, now abandoned.
Application No. 11/086,780 is a continuation of application No. 10/895,016, filed on Jul. 20, 2004, now abandoned.

(51) Int. Cl. G08B 1/08; G08B 19/00

(52) U.S. Cl. 340/539.22; 340/521; 340/539.26

(57) ABSTRACT

A remote sensor having a thermal transducer, an acoustic transducer, and a magnetic transducer. The remote sensor can communicate data from any of the transducers via any of three different communication links, which include an active RF transceiver, an IRDA transceiver, and an RF backscatter transceiver.

### CROSS REFERENCE TO RELATED APPLICATION

This application is a continuation of U.S. patent application Ser. No. 11/086,780 entitled “Remote Sensor with Multiple Sensing and Communication Modes”, filed on Mar. 22, 2005, which is a continuation of U.S. patent application Ser. No. 10/895,016 entitled “Remote Sensor with Multiple Sensing and Communication Modes”, filed on Jul. 20, 2004, the contents of each of which are incorporated herein by reference.

### GOVERNMENT LICENSE RIGHTS

The U.S. Government has a paid-up license in this invention and the right in limited circumstances to require the patent owner to license others on reasonable terms as provided for by the terms of (Contract No. 6091701-03-0008) awarded by Defense Micro Electronics Activity.

### FIELD OF THE INVENTION

This invention relates generally to remote sensors, and more particularly to remote sensors that have multiple sensing modes and/or multiple communication modes.

### BACKGROUND

In surveillance, security, and combat applications, it is desirable to monitor and detect the presence of humans and vehicles in a given area. Manned and unmanned monitoring stations have been employed using vision systems that may include infrared night vision capability.

Unattended ground sensors have also been employed. Challenges in designing and operating such unattended ground sensors include remote control of the sensor, powering the sensor, communicating the sensed data to an operator, and the limitations of the type of sensing capabilities of the ground sensor.

It is against this background and with a desire to improve on the prior art that a remote sensor has been developed.

### SUMMARY

A remote sensor device is provided that can be located remotely from and supply data to a receiving unit. The sensor device includes a sensor housing; a thermal sensor located in the sensor housing that determines the ambient temperature; an acoustic sensor located in the sensor housing; a magnetic sensor located in the sensor housing; and control logic located in the sensor housing that obtains sensor data from the three sensors and communicates it to the receiving unit.

The communication to the receiving unit may be via optical transmission of data. The communication may be via IRDA protocol and include an IRDA transmitter. The communication to the receiving unit may be via RF transmission of data, including an RF transmitter and an antenna that includes at least a portion of a guitar string. The communication to the receiving unit may be via RF backscatter transmission of data, including a patch antenna that can be controllably and selectably shorted to ground.

The communication to the receiving unit may be via a selected one of three different communication links. The three different communication links may include an IRDA communication link, an active RF communication link, and an RF backscatter communication link.

A remote sensor device is also provided that can be located remotely from and supply data to a receiving unit. The sensor device includes a sensor housing; at least one type of sensor located in the sensor housing; and control logic located in the sensor housing that obtains sensor data from the at least one sensor. The device also includes a first communication link that can communicate sensor data to the receiving unit; a second communication link that can communicate sensor data to the receiving unit; and a third communication link that can communicate sensor data to the receiving unit. The control logic determines which communication link to use in communicating the sensor data to the receiving unit.

Numerous additional features and advantages of the present invention will become apparent to those skilled in the art upon consideration of the further description that follows.

### BRIEF DESCRIPTION OF THE DRAWINGS

FIG. 1 is a block diagram of a remote sensor shown in communication with two different external communication devices.

FIG. 2 is a diagram of the packets that make up the active RF protocol.

FIG. 3 is a diagram of the encoding scheme for the symbols in the active RF protocol.

FIG. 4 is a diagram of the packet structure in the IRDA protocol.

FIG. 5 is a diagram of the encoding scheme in the IRDA protocol.

FIG. 6 is a diagram of the active RF and RF backscatter antennas.

### DETAILED DESCRIPTION

Reference will now be made to the accompanying drawings, which assist in illustrating the various pertinent features of the packaging design. Although the invention will now be described primarily in conjunction with remote sensing, it should be expressly understood that the invention may be applicable to other applications where sensing is required/desired. In this regard, the following description of a remote sensor is presented for purposes of illustration and description. Furthermore, the description is not intended to limit the invention to the form disclosed herein. Consequently, variations and modifications commensurate with the following teachings, and skill and knowledge of the relevant art, are within the scope of the remote sensor. The embodiments described herein are further intended to explain modes known of practicing the invention and to enable others skilled in the art to utilize the invention in such, or other embodiments and with various modifications required by the particular application(s) or use(s) of the remote sensor.

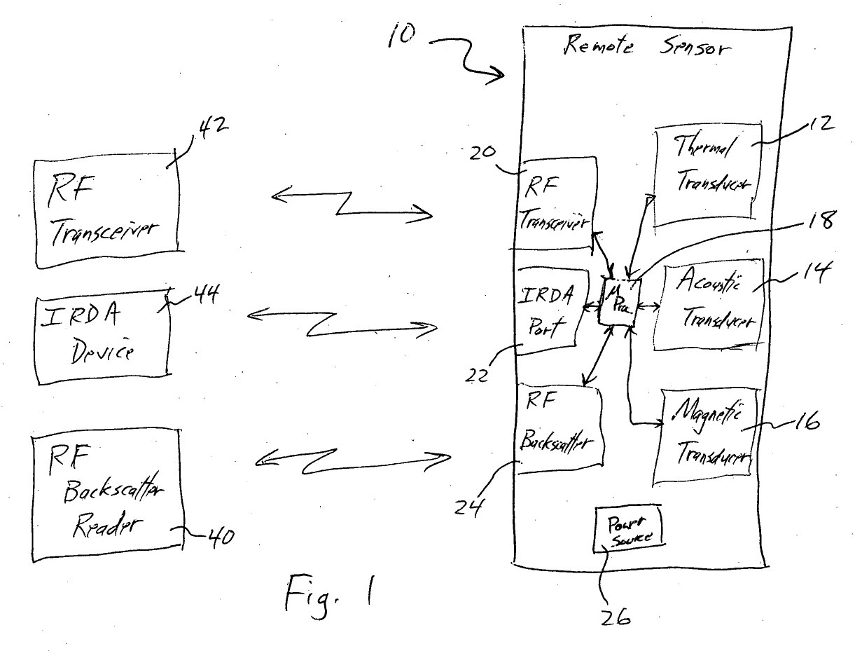

A remote sensor 10 includes a thermal transducer 12, an acoustic transducer 14, and a magnetic transducer 16, as shown in FIG. 1. Each of the transducers 12, 14, and 16 in the remote sensor 10 communicate with a microprocessor 18 also located in the remote sensor 10. The remote sensor 10 communicates with other devices via an RF transceiver 20, an IRDA transceiver 22, and/or an RF backscatter transceiver 24. Each of the components in the remote sensor 10 receives power as necessary from a power source 26, which may include a battery.

The microprocessor 18 may include a Texas Instruments MSP430F1232 16-bit microcontroller, although any other suitable microprocessor or other type of control logic would suffice. The microprocessor includes 256 bytes of RAM and 8K plus 256 bytes of flash memory. Additionally, there are five channels of 10-bit analog-to-digital converters, two hardware timers, and a SPI and UART hardware interface driver. A separate 4.0 MHz crystal (not shown) is used in the remote sensor 10 to drive the microcontroller clock. The responsibility of the microprocessor 18 is to monitor the three transducers 12, 14, 16 and three receivers of the transceivers 20, 22, and 24, decode incoming data, and generate outgoing data packets to be sent on the transmission portion of the transceivers 20, 22, and 24. Embedded internal to the microprocessor 18 is the embedded code that controls the operation of the remote sensor 10. The microprocessor 18 supports and uses end-circuit programming. A standard interface is presented for data transfer to and from the microprocessor 18.

The acoustic transducer 14 may include a microphone, a low-pass filter, a gain amplifier, and a threshold comparator. The acoustic transducer 14 may include a Sisonic SP0101NC2-2 omnidirectional microphone, although any other suitable acoustic transducer device would suffice. The microphone may be a surface mount MEMS device that has a frequency range of 100 Hz to 10 kHz. A single MCP602 operational amplifier is used on the acoustic sensor to amplify and low-pass filter the acoustic signal from the microphone. Another operational amplifier is used to generate a voltage reference used for single biasing and detection. The microphone output is biased to the midway point between the circuit supply voltage and ground to allow for both positive and negative signal swings. The biased signal is filtered with a second order low-pass Butterworth filter to remove upper frequency noise. It is then amplified with an adjustable gain that is controlled by a digital resistor potentiometer. This digital resistor operates on an I2C bus and is controlled by the microprocessor 18. Lastly, the amplified acoustic signal is threshold detected against a static voltage to detect sufficiently large acoustic signals. The digital output of the threshold detector is connected to the microprocessor 18 for processing.

The magnetic transducer 16 includes a magnetic sensor integrated circuit, a differential instrumentation amplifier, a low-pass filter, two gain amplifiers, and a threshold detector. The magnetic transducer 16 may include an NVE AA002-02 GMR (giant magneto resistive) field sensor, although any suitable magnetic sensor would suffice. This sensor has a saturation field of 15 Oe, a linear range of 0 to 10.5 Oe, and a sensitivity of 3 mV/V/Oe. Two MCP602 CMOS operational amplifiers are used on the magnetic sensor to amplify and low-pass filter the analog output signal. An INA122UA instrumentation amplifier is used as a difference amplifier for the differential output from the magnetic sensor. The magnetic sensor IC is based on Spintronics technology. Its output includes a differential voltage pair proportional to the detected magnetic field. The differential voltage pair is amplified and converted to a single voltage by the instrumentation amplifier. The AC-coupled signal is then amplified and filtered with a low-pass filter to remove upper frequency noise and boost the low-voltage signal output. The signal is amplified a second time by an adjustable gain controlled by a digital resistor similar to the acoustic sensor. Lastly, the amplified magnetic signal is threshold detected against a static voltage, to detect sufficiently large changes in magnetic fields. The digital output of the threshold detector is connected to the microprocessor 18 for processing.

A DS1803E-010 digitally controlled 10 kOhm variable resistor is used in both the acoustic and magnetic sensor circuits. It is used to adjust the gain of one gain stage in each circuit. The digital resistor is controlled through an I2C interface. A LMV393IPWR comparator is also used in both the magnetic and acoustic sensor circuits for determining when a sufficiently strong sensor signal has been detected. It compares the analog sensor signal against the voltage reference and its output is tied to the microprocessor 18 for data collection.

The thermal transducer 12 may include a Burr Brown TMP 100NA/250 12-bit digital temperature sensor, although any suitable thermal sensor would suffice. The digital temperature sensor has an operating range of −55 to +120° C., an accuracy of 0.5° C., and a maximum resolution of 0.0625° C. Even though it is a 12-bit sensor, suitable results are achieved with only 9-bit conversions with only the 8 most significant bits used. The sensor has an I2C interface and is normally kept in sleep mode for low power operation. When directed by the microprocessor 18, the thermal transducer can perform a 9-bit temperature conversion in 75 milliseconds.

The RF transceiver 20 may include an RF Monolithics DR3000 transceiver, although any suitable transceiver or separate transmitter and receiver would suffice. This transceiver 20 allows for both digital transmission and reception. The transceiver 20 has an operating frequency of 916.5 MHz and is capable of baud rates between 2.4 kbps and 19.2 kbps. It uses OOK modulation and has an output power of 0.75 mW. It also uses digital inputs and outputs for direct connection with the microprocessor 18. The transceiver 20 uses an antenna 50 (FIG. 6) that may include a 17 mil thick plain steel electric guitar G-string cut to a length of 8.18 cm. It is used in a monopole over ground configuration and requires a matching circuit of one inductor and one capacitor. Alternatively, Frequency Shift Keying (FSK), Quadrature Phase Shift Keying (QPSK), or any other suitable modulation scheme may be utilized.

The IRDA transceiver 22 may include a Sharp GP2W0110YPS infrared transceiver, although any suitable IRDA compliant infrared transceiver would suffice. This transceiver 22 is IRDA v1.2 compliant and has an operating range of 0.7 meters. It is capable of 115.2 kbps data speeds.

The RF backscatter transmission device 24 may include circuitry available from Alien Technology (of Morgan Hill, Calif.) for receiving and transmitting signals via RF backscatter. The battery in the power source 26 may be a 3.6 volt ½ AA lithium battery with a capacity of 1.2 amp hours. The power source 26 may also include a Texas Instruments TPS76930DBVT voltage regulator to regulate the output signal to 3 volts and with a maximum current of 100 mA. The voltage regulator also features a LDO.

The RF backscatter transceiver 24 in the remote sensor 10 communicates with an RF backscatter reader 40 such as a class 3 reader from Alien Technology. The reader 40 transmits data to the backscatter transceiver 24 of the remote sensor 10 by broadcasting encoded RF pulses and receives data back from the transceiver 24 by continually broadcasting RF energy to the sensor 10 and monitoring the modulated RF reflections from the sensor 10. The sensor 10 modulates the RF energy by tuning and detuning its antenna 52. This requires far less power on the sensor side for data transmission since no power from the sensor 10 needs to be transmitted. This makes RF backscatter communication the most desirable communication link in regards to power consumption. With regard to circuit complexity, however, this communication link may be less desirable because the necessary hardware is complex, expensive, and the communication range may be limited.

The RF backscatter transceiver 24 on the sensor 10 includes a printed circuit board (PCB) patch antenna for RF reception, and RF modulation, a Schotky diode detector circuit, a comparator circuit for signal decoding, and a logic circuit for wake-up. The logic circuit monitors the incoming data, and when an appropriate wake-up pattern is detected, it triggers the microprocessor 18 so that data reception can begin. The reader 40 has an operating frequency between 2402 MHz and 2480 MHz, and it uses frequency hopping in this band to reduce noise interference. A modulation method used by the reader 40 is On-Off Keying (OOK). The transmission power is 1 watt. The operation of the reader 40 may be controlled by an external computer (not shown) as directed by Labview software via a RS-232 serial link.

The RF transceiver 20 of the remote sensor 10 may communicate with an external RF transceiver 42 such as a DR3000 transceiver from Radio Monolithics, Inc. It operates at 916.5 MHz, uses OOK modulation, has a communication range of 100 meters line of sight, and a baud rate of 19.2 kbps. The active RF antenna 50 is a quarter-wavelength monopole made from a guitar G-string and appropriate matching circuitry. Two control lines from the microprocessor 18 select the mode of operation, choosing from transmit, receive, and sleep. The active RF receiver consumes the most power in receive mode compared to the other two communication links. FIG. 6 shows the relative positioning and shape of the active RF antenna 50 and the RF backscatter antenna 52.

The IRDA transceiver 22 of the remote sensor 10 communicates with an external IRDA transceiver 44 that may be identical to the IRDA transceiver 22. Alternatively, the IRDA transceiver 44 could be one such as is provided in most personal digital assistants (PDA) as well as many other consumer devices. The IRDA communication link follows the standard IRDA signal and coding protocol and is modeled after a standard UART interface. The IRDA transceiver 22 is capable of data speeds less than 115.2 kbps, and may only have a range of 0.7 meters for transmission. One advantage of the IRDA communication link is that it does not require any of the RF spectrum for operation, but it typically does require line-of-sight communication.

When any one of the transceivers 20, 22, and 24 on the remote sensor 10 detect the beginning of valid data on their respective communication link, all other transceivers are disabled, thereby preventing the corruption of incoming data with the noise or partial data packets on the other communication links. However, if the data on the active transceiver proves to be erroneous, the other transceivers will be re-enabled if appropriate to allow normal operation to continue. If the data received by the active transceiver is valid, however, the other transceivers will remain disabled for several hundred milliseconds longer in the high probability that the next data packet will be transmitted on the same communication link. If, after this extended delay, no additional packets are received, then the other transceivers will be re-enabled as appropriate.

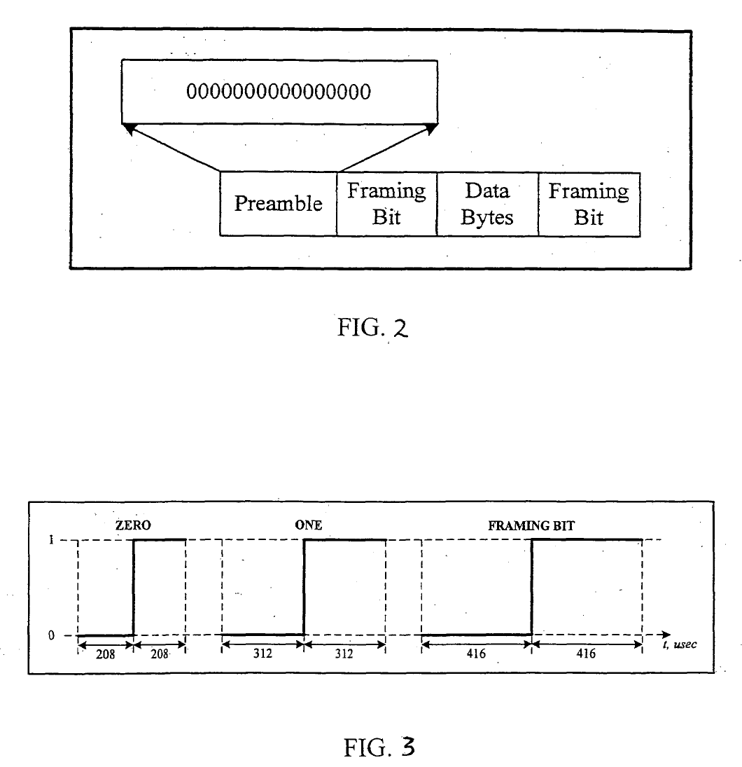

The active RF protocol has no wake-up or synchronization packets, and the packets sent to and from the sensor are identical. The format of an active RF packet is shown in FIG. 2. It includes a preamble to reset and spin-up the state machine of the RF receiver and to properly bias the receiver's data slicer/threshold detector for optimum noise rejection and signal regeneration, two framing bits to indicate the beginning and end of the data bytes, and the data bytes themselves. Furthermore, the encoding scheme for the three symbols is shown in FIG. 3. The entire packet is DC balanced to maintain an optimal level on the data slicer/threshold detector and the receiver. Data is sent most significant bit first.

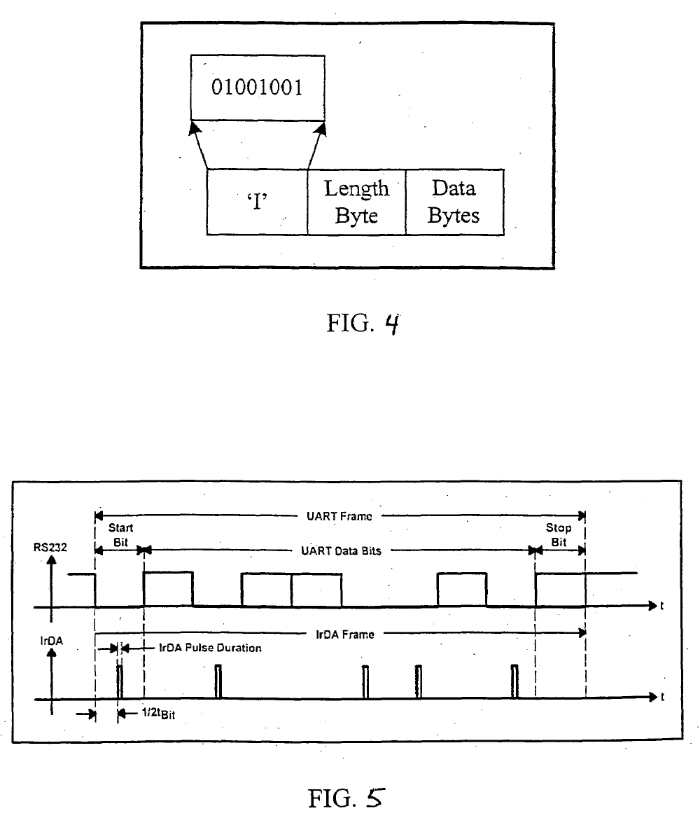

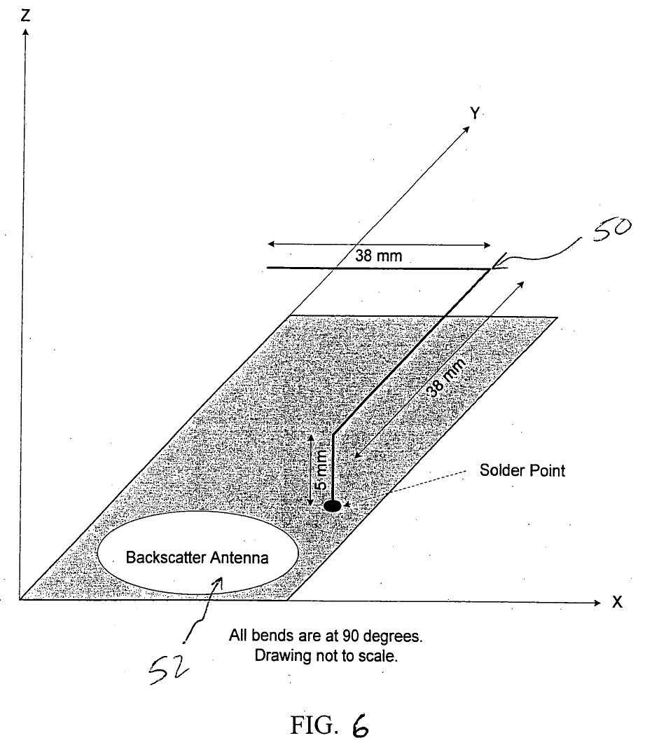

The IRDA communication link follows the standard IRDA protocol for bit encoding and UART protocol for byte transmission. Packets transmitted on the IRDA link contain no preamble or framing bits, but they do have a header that contains two bytes. The first byte is an ASCII “I” which denotes the beginning of a valid IRDA packet. The second byte equals the number of preceding bytes in the packet. This value is used by the receiver to determine when the entire packet has been received and processing of information can begin. The packet structure is shown in FIG. 4 and the IRDA/UART encoding scheme is shown in FIG. 5 (which was obtained from Texas Instruments: SLA044). Furthermore, the UART protocol characteristics are listed in Table 1. Data is sent least significant bit first.

TABLE 1
IRDA Link

| | |
|---|---|
| Bps | 9600 |
| Data bits | 8 |
| Parity | None |
| Start/Stop bits | 1/1 |
| Flow Control | None |
| Character Echoing | None |
| IRDA Pulse Duration | 4 usec |

The data bytes contained in a packet transmitted to the sensor 10 through any of the communication links conform to a packet format. The CMD section of a packet is a single byte that identifies the type of packet being sent. The CMD byte appears above the beginning and end of the packet and the two must be identical. The reason for including the redundant byte is to further eliminate the chance of a packet's CMD identifier being corrupted at the receiver, even if the CHECKSUM is correct.

The PAYLOAD contains all of the data that must be sent to, or returned from, the sensor. The PAYLOAD is broken down into individual bytes with the overall number of bytes and their content dependent on the type of packet being sent.

The CHECKSUM is a 16-bit CRC that is performed on all bytes in the data packet excluding the end CMD byte in packets generated by the external device. The CHECKSUM is sent most significant byte first.

There are tradeoffs as to which communication device/protocol is optimal depending on the application. The tradeoffs are mainly due to environmental conditions and hardware capabilities. For example, the active RF protocol has a relatively long range of operation, operates in most environmental conditions, and has relatively high bandwidth, but it suffers from relatively high power consumption and cost. On the other hand, the RF backscatter communication link has a relatively low power consumption and cost and operates in most environmental conditions, but it has a relatively shorter range of operation and lower bandwidth. The IRDA communication link is somewhere between the other two on power consumption, bandwidth, and cost, but it also has a relatively short range of operation and generally must operate in line-of-sight conditions

It should be understood that the remote sensor 10 specifically described herein is suitable for demonstration purposes, but may need to be modified or upgraded for more realistic environments. For example, the transceivers 20, 22 and RF backscatter transmission device 24 may be required to communicate over a greater distance than do the components described herein. Upgrading these components to be suitable for longer distance transmission is considered to be within the spirit of this invention. Further, although the active RF, infrared, and RF backscatter communication links are described as including transceivers 20, 22, and 24 in the remote sensor 10, it may be possible to realize the objectives of this invention using only transmitters and without the need to receive signals remotely. In addition, it may be desirable to utilize a different number of transducers than the three transducers 12, 14, and 16 described herein, and the spirit of the invention is considered to include any multiple number of transducers. Furthermore, the type of transducer is not limited to the specific transducer types described herein. In addition, the logic described herein for arbitrating between which communication device to use to communicate with the outside world and which sensor data to provide at what time is but one possible approach to arbitration logic within such a remote sensor 10. It is considered that other types of arbitration logic will also be within the spirit of this invention.

The foregoing description of the remote sensor has been presented for purposes of illustration and description. Furthermore, the description is not intended to limit the invention to the form disclosed herein. Consequently, variations and modifications commensurate with the above teachings, and skill and knowledge of the relevant art, are within the scope of the invention. The embodiments described hereinabove are further intended to explain best modes known of practicing the invention and to enable others skilled in the art to utilize the invention in such, or other embodiments and with various modifications required by the particular application(s) or use(s) of the invention. It is intended that the appended claims be construed to include alternative embodiments to the extent permitted by the prior art.

What is claimed is:

1. A remote sensor device that can be located remotely from and supply data to a receiving unit, the sensor device comprising:
a sensor housing;
a thermal sensor located in the sensor housing that determines the ambient temperature;
an acoustic sensor located in the sensor housing;
a magnetic sensor located in the sensor housing; and
control logic located in the sensor housing that obtains sensor data from the three sensors and communicates it to the receiving unit.

2. A device as defined in claim 1, wherein the communication to the receiving unit is via optical transmission of data.

3. A device as defined in claim 2, wherein the communication is via IRDA protocol.

4. A device as defined in claim 3, the device further including an IRDA transmitter.

5. A device as defined in claim 1, wherein the communication to the receiving unit is via RF transmission of data.

6. A device as defined in claim 5, the device further including an RF transmitter.

7. A device as defined in claim 6, wherein the device includes an antenna that includes at least a portion of a guitar string.

8. A device as defined in claim 1, wherein the communication to the receiving unit is via RF backscatter transmission of data.

9. A device as defined in claim 8, the device further including a patch antenna that can be controllably and selectably shorted to ground.

10. A device as defined in claim 1, wherein the communication to the receiving unit is via a selected one of three different communication links.

11. A device as defined in claim 10, wherein the three different communication links include an IRDA communication link.

12. A device as defined in claim 10, wherein the three different communication links include an active RF communication link.

13. A device as defined in claim 10, wherein the three different communication links include an RF backscatter communication link.

14. A device as defined in claim 10, wherein the three different communication links include an IRDA communication link, an active RF communication link, and an RF backscatter communication link.

15. A remote sensor device that can be located remotely from and supply data to a receiving unit, the sensor device comprising:
a sensor housing;
at least one type of sensor located in the sensor housing;
control logic located in the sensor housing that obtains sensor data from the at least one sensor;
a first communication link that can communicate sensor data to the receiving unit;
a second communication link that can communicate sensor data to the receiving unit; and
a third communication link that can communicate sensor data to the receiving unit;
wherein the control logic determines which communication link to use in communicating the sensor data to the receiving unit.

16. A device as defined in claim 15, wherein the at least one type of sensor is a thermal sensor.

17. A device as defined in claim 15, wherein the at least one type of sensor is a magnetic sensor.

18. A device as defined in claim 15, wherein the at least one type of sensor is an acoustic sensor.

19. A device as defined in claim 15, further including another type of sensor located in the sensor housing.

20. A device as defined in claim 19, further including a third type of sensor located in the sensor housing.

21. A device as defined in claim 20, wherein the three types of sensors are a thermal sensor, a magnetic sensor, and an acoustic sensor.

22. A device as defined in claim 15, wherein the first communication link is via optical transmission of data.

23. A device as defined in claim 22, wherein the first communication link is via IRDA protocol.

24. A device as defined in claim 23, the device further including an IRDA transmitter.

25. A device as defined in claim 15, wherein the second communication link is via RF transmission of data.

26. A device as defined in claim 25, the device further including an RF transmitter.

27. A device as defined in claim 26, wherein the device includes an antenna that includes at least a portion of a guitar string.

28. A device as defined in claim 15, wherein the third communication link is via RF backscatter transmission of data.

29. A device as defined in claim 28, the device further including a patch antenna that can be controllably and selectably shorted to ground.
